(19) United States
(12) Patent Application Publication
(10) Pub. No.: US 2005/0035667 A1
(43) Pub. Date: Feb. 17, 2005

(54) Multipole switch and automatic polarity adjusting switching system

(76) Inventor: Constantinos Joannou, Nepean (CA)

Correspondence Address: David J. French, Stn. "D", P.O. Box 2486, Ottawa, K1P 5W6, CA

(21) Appl. No.: 10/624,611

(22) Filed: Jul. 23, 2003

(51) Int. Cl. H02H 1/00

(52) U.S. Cl. 307/125

(57) ABSTRACT

A multi-pole switch with a neutral position is provided with an efficient mechanical layout. Such switch is suitable for use in relay format in an automatic battery booster cable system to be used to connect a polarized source and a polarized load, eg. two batteries together in parallel, with automatically correct polarity. The relay switch in the booster cable application is driven by an electronic controller which senses the polarity of the two batteries and connects the two batteries with the correct polarity. The electronics provides features for setting the relay to neutral, thereby disconnecting the source from the load when any of the cables are disconnected, while maintaining current flow under high load conditions. The booster cable system also employs direct inter-connections between the cable conductors and the relay contacts thus simplifying the construction of the relay. The relay makes use of resilient polymeric elements instead of coiled springs to minimize relay re-bound.

### FIELD OF THE INVENTION

This invention relates to a multi-pole format electrical switch. It further addresses an automatic polarity adjusting switching system. For example, it is useful for connecting batteries in parallel, as well as other applications. In particular, it relates to a switching arrangement forming an integral part of a booster cable which assembly enables the operator to connect the cables to two batteries in parallel without having to worry about finding the correct polarity. It can also be used wherever a heavy duty, electronically actuated, multi-pole, single or double-throw switch is required.

### BACKGROUND OF THE INVENTION

Using the booster cable situation as an example, it is desirable to provide an automatic switching system that can transfer high current of the correct polarity between two batteries with a minimum voltage drop. In order for correct polarity connections to be established, the system must determine the relative polarities of the two batteries and do so automatically. In the case of the discharged battery, its polarity may only be indicated by a very low voltage level. At the same time, the system must distinguish the case when the cables on the discharged battery side of the switch are not connected at all, i.e., are receiving a zero-level voltage input.

Further, once the switch has been actuated to supply current to a discharged battery, the system should thereafter detect a disconnected condition and switch the charging-side cables to a “dead” condition. Otherwise, disconnected cables that have been activated, if they were to touch each other could cause a high current short.

These and other issues have already been addressed by prior art in this field.

In the previous art, several patents teach methods of automating the battery boosting process using as a supply source a supply battery to provide current to a discharged battery. These methods address the issue of providing a polarity adjusting switching system that ensures that the positive poles are connected to each other, and the negative poles are connected to each other to ensure that a parallel connection format is established.

U.S. Pat. No. 4,400,658 by Yates is an example of an impractical automatic booster cable arrangement. An improvement was described in U.S. Pat. No. 5,103,155 and Canadian Pat. No. 2,056,645 by myself, which is an improvement over the Yates patent because it uses amplifiers to detect the voltage of the dead battery. In this way, the dead battery can have a very small voltage, down to approximately 0.03 volts and the system will still work. However, the mechanical aspect of the U.S. Pat. No. 5,103,155 patent as described has the disadvantage that it calls for coil spring elements which are liable to rebound when the solenoid is released and can momentarily connect the batteries the wrong way.

Another pertinent patent is U.S. Pat. No. 6,262,494 to Shian-Fang Sheng, in which a more practical arrangement is described but which is more complicated, using four ordinary solenoids and a complex digital circuit to drive them. Another complication is that it calls for special cables which contain sensing wires inside the heavy current wires to enable the device to sense when the clamps are disconnected from the batteries in order to switch the system off.

The present invention addresses a booster cable system which improves upon these prior art designs. It does so through use of a double-pole, double-throw switch of a novel structure.

The invention in its general form will first be described, and then its implementation in terms of specific embodiments will be detailed with reference to the drawings following thereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

The objects of this invention include providing both a multi-pole, single or double-throw automatic switch having a neutral position of novel design. As such it is readily adaptable to a double-pole, double-throw polarity reversing switch with a neutral position wherein the switching can either be mechanically operated or electrically activated by a solenoid. The switch according to the invention includes the features of:
a) employing simplified solenoid construction;
b) using resilient rubber instead of springs in the relay to avoid rebound of the contacts when the relay releases into its neutral position; and
c) using heavy duty conductors that are efficiently coupled to the switch in fixed, immobile orientations;
   Further, this switch is ideally suited to a polarity reversing application such as an automatic booster cable system when combined with:
d) an electrical circuit which can sense the voltage and polarity of the dead, to-be-charged battery down to very low levels, and
e) an electrical circuit which can sense when not all of the cables are connected, and will correspondingly deactivate the relay, while ensuring that the circuit will deliver current continuously when all batteries are fully connected.

More particularly, according to one aspect of the invention, a double or multi-pole, single or double-throw switch with a neutral position is provided wherein a solenoid-actuated construction is provided in the form of a series of fixed, parallel, contactor bars connected to heavy duty conductors and supported in a non-conductive frame. Such contactor bars are interspaced with shiftable contactors. The shiftable contactors are preferably generally washer-shaped and have central support openings for mounting, through such support openings, on an alignment shaft. The shiftable contactors are slideably positioned on the alignment shaft to effect contact with the contact bars in a “closed” configuration, or to be withdrawn into an “open” condition.

In one variant the contactor bars and shiftable contactor are assembled in combinations that will constitute switch closures for either of the two conducting configurations of a multi-pole, double-throw switch. Additionally, the shiftable contactors may assume an intermediate, neutral position providing an “open” condition. Solenoids are preferably used to displace the shiftable contactors along the alignment shaft upon activation of at least one of the solenoids. Alternately, the switch may be mechanically activated by suitable drive means.

Resilient polymeric spring means are preferably employed along the alignment shaft. These are installed towards the ends of the alignment shaft and between the shiftable contactors in the relay and the contactor bars. Their function is to cushion the closing of the switch and to bias the positioning of such shiftable contactors into a neutral position while avoiding or minimizing rebound of the shiftable contactors when, upon deactivation of the solenoids or mechanical activation, the relay returns into a neutral condition.

According to a further aspect of the invention, the heavy duty conductors in a set of jumper cables are directly coupled to the fixed contactor bars of the switch. This connection is achieved without imposing any curvature on the conductors as they engage with such contactor bars, or even as they approach such contactor bars. Further, this connection and the cable conductors remain immobile during switching operation. The contactor bars are punched at one end to form an opening in such end into which the stripped cable ends are pressed and the extended ends of the opening are then squeezed onto the cable conductors to become crimped in place.

According to a further feature of the invention in its booster cable application, an electrical circuit is provided which can sense the polarity of a heavily discharged battery down to very low voltage levels through the power cables. Thus the system has a sensing capacity which allows it to distinguish the polarity of a discharged battery that provides only a low level of voltage. This is achieved through use of a differential circuit which compares the voltage on the discharged battery to the voltage of the supply battery.

According to a further feature of the invention an electrical circuit is provided which can sense, after an initial connection has occurred and the switch has been activated, whether one of the cables has become dis-connected. This is achieved by a circuit which momentarily deactivates the switch returning the discharge side cables to a “dead” condition. During the period of disconnection, the voltage sensing circuit “polls” for the presence of voltage, and if the voltage is not there the relay will stay in its neutral position.

This polling circuit incorporates a pulse generator the output of which provides a positive test pulse with, for example, a 10 percent duty cycle and a suitable sampling frequency, conveniently in the range of 0.5 to 2 cycles per second. Each pulse disables activation of the solenoids for the duration of the pulse. This places the relay in a neutral position. If any of the clamps are at that time disconnected, then the relay will stay in its neutral position. This occurs because there will either be no voltage at the dead-battery side of the system, allowing the “connected” sensing circuitry to maintain an “open” condition; or the cables on the good battery or supply side power supply side will go to zero disabling the connection circuitry. In this manner the system remains switched OFF following a test pulse when any clamp is disconnected from a battery.

As the last procedure leads to repeated opening and closing of the switch while the “connected” status of the cables is being polled, such repeated cycling can be wearing on the switch if the switch is carrying a high current. To avoid such wear, the system may include a sensing means which suspends the polling activity while the switch is carrying high current.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIGS. 1a, 1b and 1c depict the double-pole, double-throw switch of the invention in its respective two connected and one neutral positions.

FIG. 1d is a schematic drawing showing the electrical/electronic solenoid control circuitry of the system.

FIG. 2 shows a cross section of the relay in its neutral position.

FIG. 3 shows the reversing switch of FIG. 2 displaced in one direction.

FIG. 4 shows the reversing switch of FIG. 2 displaced in the other direction.

FIG. 5 shows a pictorial view of the reversing relay with the contactors crimped onto the cables to form the interconnections with the relay contacts.

FIG. 5a shows a typical switch contactor which is formed with an opening to be fitted around the conductor core of a cable but before crimping.

FIG. 5b shows a partial pictorial view of two electrode contact bars crimped to an exposed conductor core of the cable.

FIG. 6 shows a pictorial view of a receptacle in which the cables can be fastened with the solenoids, alignment shaft and a printed circuit board arranged in the case.

FIG. 7 shows the whole booster cable assembly wherein the cables to be connected to the good battery during boosting are shorter than the ones to be connected to the weak battery.

FIG. 8 shows a complete case containing the booster cable system without the cables attached, wherein the cables can be attached to the system by available set-screws.

FIG. 8a shows a detailed view of the attachment mechanism for the cables.

### DETAILED DESCRIPTION OF THE PREFERRED EMBODIMENT

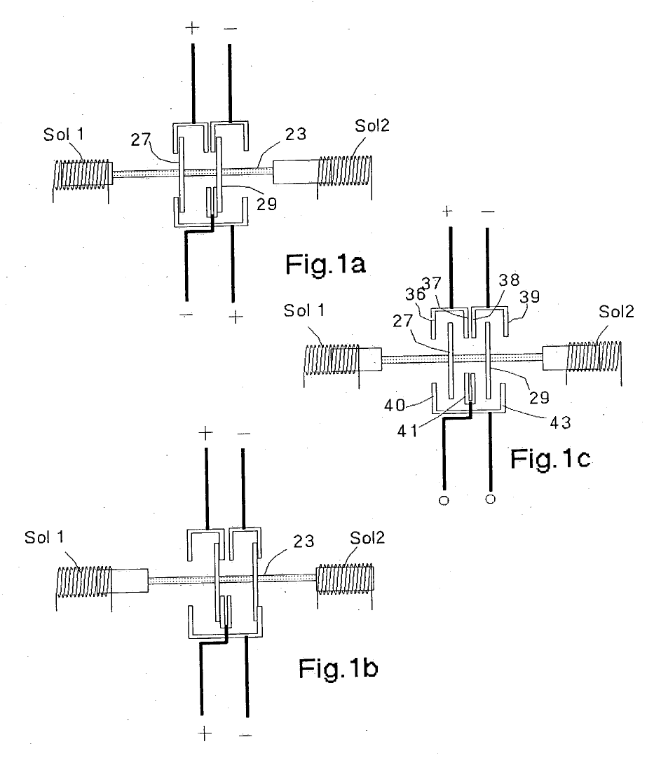

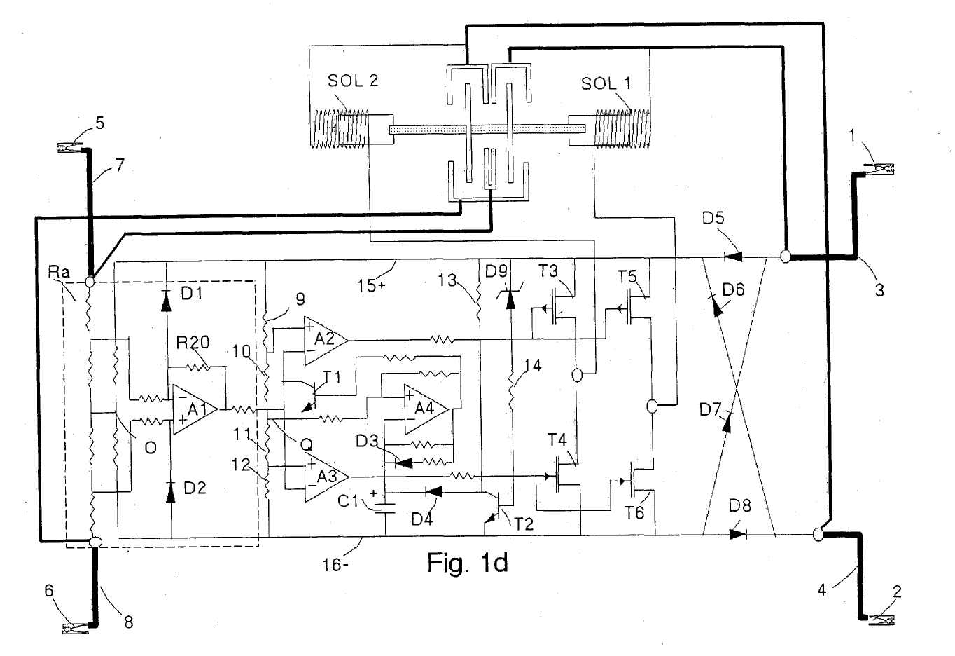

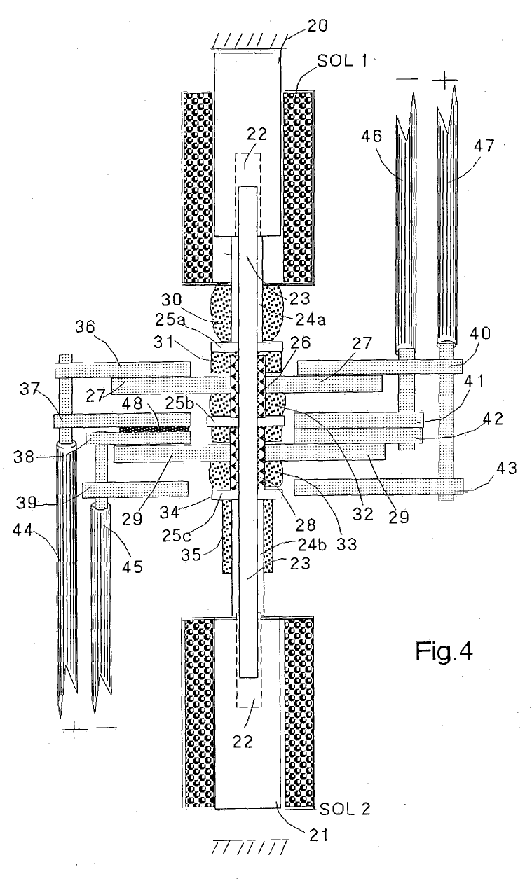

FIGS. 1a, 1b and 1c depict the layout of a preferred embodiment of the switch of the invention wherein fixed contactor bars 36 to 43 are contacted by moveable contactors 27, 29. The solenoids Sol 1 and Sol 2 displace the shiftable contactors 27, 29 along the alignment shaft against the fixed contactor bars 36 to 43 to effect switch closures, cf FIGS. 1a, 1b. Resilient compressible sleeves 30, 35 (FIG. 4) restore the shiftable contactors 27, 29 to a neutral “open” position (FIG. 1c) when neither of the solenoids Sol 1, Sol 2 are activated.

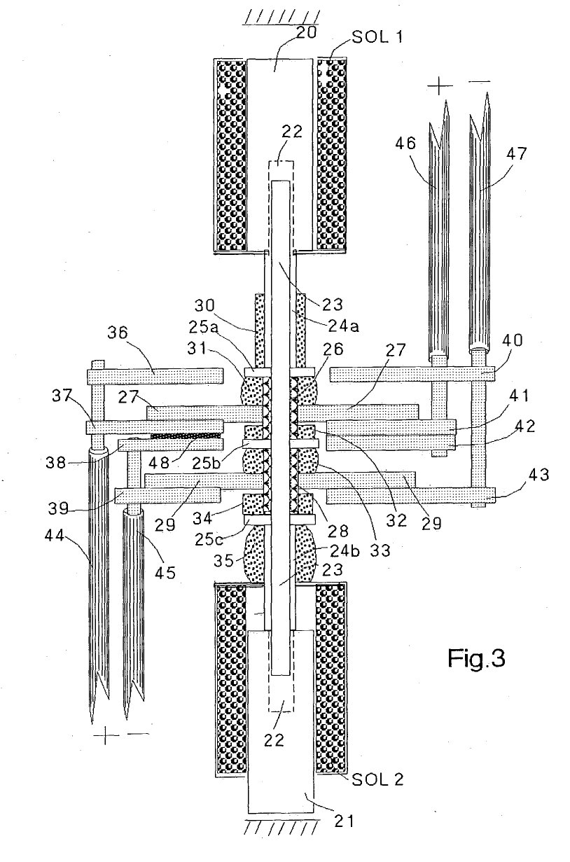

FIGS. 3 and 4 show these sleeves in their two compressed conditions. FIG. 3 shows the sleeves in a first compressed configuration occurring when Sol 1 is activated. FIG. 4 shows a second compressed configuration that occurs when Sol 2 is activated.

For the purpose of describing the operation of the control circuitry, we will describe the particular case in which the “load” presented at connectors 5,6 is a “weak” battery, and the “source” presented at connectors 1, 2 is a charging device, in particular a “strong” or “good” 12 volt battery (see FIG. 1d).

It should be appreciated that this is a particular example. DC devices of higher or lower voltages could be handled and the load and source may be other than batteries.

Referring to the circuit diagram of FIG. 1d clamps 1,2 are to be attached to the good battery, and clamps 5, 6 are to be attached to the weak battery to be charged. While reference is made to a “good battery” this supply-side power supply can be a generator or other equivalent power source. Rectifier diodes D5 to D8 provide the proper polarity to supply lines or “rails” 15+ and 16−, irrespective of the polarity of the terminals to which the battery clamps 1, 2 are connected. Supply lines 15+ and 16− provide battery voltage (example 12 volts) and current to the rest of the electronic driver circuits.

The weak battery connected to clamps 5 and 6 provides a differential voltage to amplifier A1 and to the voltage divider network Ra. While reference is made to a “weak battery” this is exemplary of any polarized load that presents a voltage that can be sensed. Amplifier A1 provides a positive output or a negative output with respect to the voltage at point O, which has a potential of half the voltage between lines 15+ and 16− (e.g., 6 volts). Differential comparator A2 has its positive input connected to a point between resistors 9 and 10. Such input may be at a potential of about, for example, 9 volts. Differential comparator A3 has its positive input connected between resistors 11 and 12 and maybe at a potential of, for example, 3 volts. The negative inputs of both comparators A2, A3 are connect to the output of amplifier A1, which is at 6V potential when there is a zero input to A1 from cables 7, 8. This is the condition when there is no battery to be charged connected to clamps 5, 6.

All resistors 9, 10, 11 and 12 have equal values. Therefore, depending on the output voltage of A1, if it is positive and more than, for example, 9 volts, (the threshold value set between resistors 9, 10), A2 and A3 will output a negative output. This output will switch transistors T3 and T5 ON but nothing will then happen to T4 and T6, which require a positive input to switch ON. If amplifier A1 outputs a negative output, then A2 and A3 output a positive voltage, which will turn ON T4 and T6 without affecting T3 and T5. Note that if A1 outputs no voltage with respect to point O, or a voltage below, for example, 3 volts, then A2 outputs a positive output and A4 outputs a negative output. In this case, no power transistor is turned ON.

Feedback resistor R20 on amplifier A1 controls the gain of this amplifier and therefore the sensitivity of the circuit as to the threshold level of voltage on the discharged battery below which the system will not operate to effect closing of the switch. Sufficient voltage must be present to establish the polarity of the battery and enable the switch to operate appropriately. Threshold values as low as 0.03 volts have been tested successfully.

When T3 and T5 are turned ON, either solenoid Sol 1 or solenoid Sol 2 will operate, depending on the polarity at clamp 1 and clamp 2. If clamp 2 is negative, only solenoid Sol 1 will operate and if clamp 1 is negative, only solenoid sol 2 will operate. Similarly, reversing the polarity at clamps 5 and 6 will cause T4 and T6 to turn ON and again, depending on the polarity at clamps 1 and 2, the solenoid connected to the positive clamp will operate.

The two solenoids Sol 1, Sol 2 operate mechanical contacts which connect the two batteries correctly no matter what the polarity is at the clamps, based upon a double-pole, double-throw switching system.

While solenoids Sol 1, Sol 2 are shown, any form of “drive means” which will displace the shiftable contactors 27, 29 may be employed. This may include mechanical buttons or levers etc. that are manually operated

Another aspect of the invention is the method by which the relay goes to neutral when any of the battery terminals are disconnected. In FIG. 1d, differential amplifier A4 is connected as a pulse generator that produces produce a positive pulse with a duty cycle of about, for example, 10 percent at a convenient sampling rate. The output of A4 is then coupled to the base of transistor T1 to switch it ON 10 percent of the time. When T1 is switched ON, the negative inputs of comparators A2 and A3 are connected to point Q of the circuit which is at 6 volt potential, the same value as point O. During this instant, the output of A2 goes positive and the output of A3 goes negative, which is the state of the circuit when the voltage between clamp 5 and clamp 6 is zero, i.e., disconnected. During this time, both solenoids are not operating, putting the relay in the neutral position. If any of the clamps are disconnected, the relay will then stay in its neutral position because either there will be no voltage at the dead battery side of the system, or the power supply lines will, through clamps 1,2, be at zero. In this way the system switches OFF when any clamp is disconnected, without resorting to extra sensing wires embedded in the current carrying cables.

In order to prevent heavy arcing during this 10 percent interruption, such as when the vehicle with the weak battery is trying to start its engine, a pulse suppression circuit may be built into the system that senses a high current flow through a drop of voltage at clamps 1,2 and prevents the pulse generator from pulsing. This allows the relay to stay ON continuously. This pulse suppression circuit may consist of zener diode D9, resistor 14, transistor T2, resistor 13, capacitor C, and diode D4. When the voltage between lines 15+ and 16− is 12 volts or greater, the voltage drop of the zener diode D9, which is at say 10 volts, leaves a voltage across resistor 14 sufficient enough to keep enough current in the base of T2 to keep the transistor conducting. Then, since the voltage across the transistor is close to zero and diode D4 is back-biased, this allows the pulse generator A4 to pulse.

When the voltage between line 15+ and 16− is lower than say 10 to 11 volts, for example, then transistor T2, does not have enough current in its base and it switches OFF. This causes resistor 13 to allow current to flow through diode D4 (forward biasing it) and thus stopping A4 from pulsing because capacitor C1 is made to increase its voltage and cut-off oscilation.

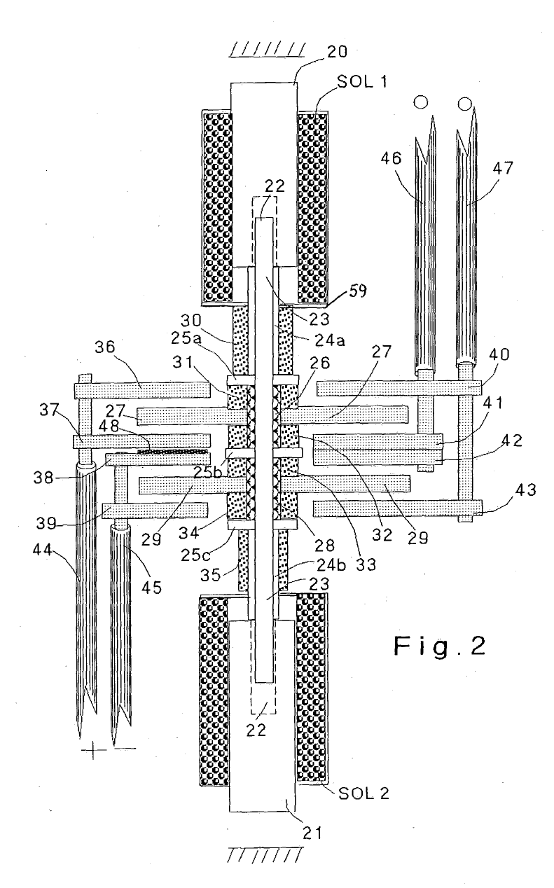

FIG. 2 shows diagrammatically the mechanical layout of the reversing relay, which is operated by the two solenoids Sol 1 and Sol 2 described above. The relay is shown in its neutral position in FIG. 2. Plungers 20, 21 are positioned within the respective solenoids. The plungers 20, 21 have an opening 22 where alignment shaft 23 is accommodated. Solenoids Sol 1 and Sol 2, when respectively energized, attract plungers 20 and 21 which bear against sleeves 24a and 24b compressing resilient tubes 30 to 35. Sleeves 24a and 24b are fixed on shaft 23 and carry alignment shaft 23 with them when they are displaced. Mandrel 26 slidingly supports a moveable contactor, e.g. copper washer 27; and mandrel 28 slidingly supports a second moveable contactor, e.g. copper washer 29. Washers 25a, 25b and 25c are fixed along shaft 23 bounded and interspersed by resilient tubes 30, 31, 32, 33, 34 and 35 made of silicon rubber or a similar material of suitable resilience. Strips of copper serving as contactor bars 36 to 43 are crimped on the exposed portion of the conductors of cables 44 to 47. Copper washers 27 and 29 and copper contactor strips 36 to 43 form the relay contacts. Copper is used as a preferred, low cost, highly conductive metal with good contact resistance. Silver, e.g. silver plated contacting surfaces may also be employed.

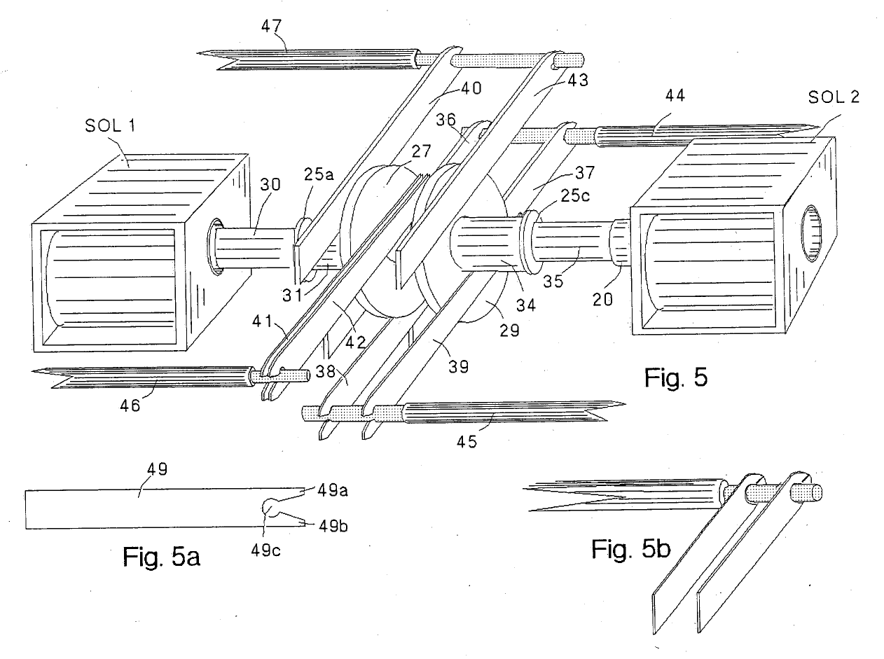

The relay described in FIG. 2 above is wired to provide a polarity reversing relay. (Also, refer to FIG. 5 for a more detailed description of an alternate physical arrangement or layout for the relay). It operates as a double-throw, double-pole reversing switch. In FIG. 2, cables 44 and 45 are connected to the good battery optionally with polarity as shown. In its neutral position in FIG. 2, neither of the solenoids Sol 1, Sol 2 are energized and copper washers 27, 29 do not contact any of the other copper strips or bars (electrodes) 36 to 43 and therefore cables 46 and 47 have no voltage across them.

FIG. 3 shows the case where solenoid Sol 1 is energized. In this state plunger 20 is pulled into solenoid Sol 1 and pushes sleeve 24a against washer 25a, which pushes against mandrel 26, washer 25b, mandrel 28, and washer 25c. Copper washers 27 and 29 are free to move along mandrels 26 and 28. As a result, resilient tube 31 pushes against washer 27, which, in turn, is squeezed against copper bars or contactor strips 37 and 41. Similarly, resilient tube 33 squeezes washer 29 against copper bars or strips 39 and 43. In this state, cable 44 makes connection to cable 46 and cable 45 makes connection to cable 47. Insulator 48, which need not be very thick, e.g., 0.01 inches of MYLAR™, is used to prevent strip 37 from touching strip 38.

FIG. 4 shows the case where solenoid Sol 2 is energized. In this case the above events are correspondingly reversed and cable 44 connects to cable 47 while cable 45 connects to cable 46. Resilient tubes 30, 35 are seated on cap ends 59 on the respective solenoids SoL 1, SoL 2. In other words, the polarity of the connection to cables 46 and 47 is reversed. The function of resilient tubes 30 and 35 is to open the switch to a neutral state by centering washers 27 and 29 as in FIGS. 1c and 2, and such tubes, 30, 35 are dimensioned accordingly. The function of tubes 31 to 34 is to ensure that the shiftable contactors 27, 29 bear intimately against the contactor bars 36-43 with a low resistance contact.

The reason resilient polymeric tubes 30 to 35 are used instead of coil springs is that resilient tubes, when deformed and released, have a reduced tendency to over-respond or bounce back compared to coiled springs. Further these tubes 30 to 35 may be made of a material, such as silicon rubber for instance, which does not significantly change its resiliency with temperature.

In the operation of the relay, it is advantageous to minimize the total moving mass which the solenoids Sol 1, Sol 2 displace. The smaller this mass is, the faster the relay operates and the more the rebound is minimized. To achieve lower mass, plungers 20, 21 are not fixed to shaft 23, and openings 22 allow room for the alignment shaft 23 to move within the plungers 20, 21. In this way, when any of the plungers 20, 21 are released, they do not carry the opposite plunger with it.

FIG. 5 shows a convenient arrangement for effecting connections to the cables of the reversing relay. The four cables 44 to 47 connect to the copper bars or strips 36 to 43 which form the fixed relay contacts. These bars or contractors are shown as extending past the center line in FIG. 5 (as opposed to FIG. 4) as this is permissible due to the vertical offset. FIGS. 2 to 4 have been simplified for ease of presentation. Also the cable connections to bars 36 to 43 are repositioned in FIG. 5 as opposed to FIG. 4 for convenience of layout, but with the same electrical effects.

FIG. 5a shows a typical copper contactor strip 49 prior to assembly. The strips are punched at one end to form an opening 49c into which the stripped conductors at the cable ends are pressed. The extended ends 49a, 49b of the openings 49c are then squeezed onto the cable conductors as shown in FIG. 5b. This crimping procedure makes it easy to assemble the relay. It also provides a direct connection between the conductors of cables 44 to 47 and the contactor strips 36-43.

Conveniently, these connections and the cables 44 to 47 do not move at any time during the operation of the relay. Further, the conductors lie straight, without curvature both between multiple contactor connections and approaching such connections. This is an especially desirable feature when heavy gauge conductors are employed.

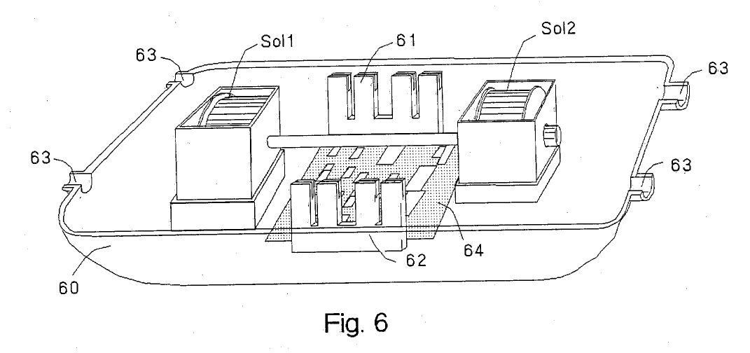

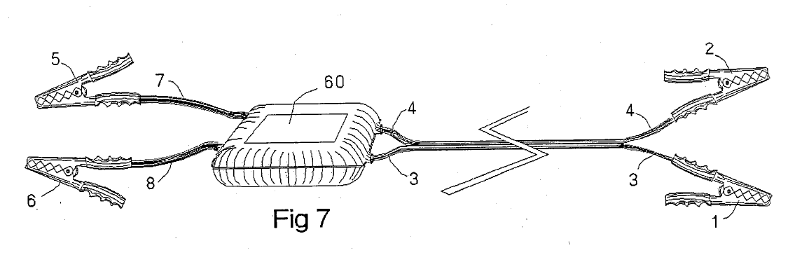

The relay assembly is preferably mounted within and enclosed by a plastic casing 60, which is partly shown in FIG. 6 and fully shown in FIG. 7. A non-conductive frame of supports 61, 62 seated on case 60 serves as a holder for the contactor bars 36 to 43. The electronics are conveniently mounted on a circuit board 64 positioned beneath this frame. Four ports 63 are provided in the case 60 for cable entry.

FIG. 7 shows the complete booster cable system. Note that cables 7 and 8 that are to be connected to the good battery are visibly shorter than cables 3 and 4 that are to be connected to the weak battery. This serves as an indicator that makes it easier to recognize the two sets of cables and ensures that the voltage developed across lines 15+ and 16− is the full, good battery voltage. Other indicia, such as markings, may alternately be employed to identify the cables to be connected to the good battery.

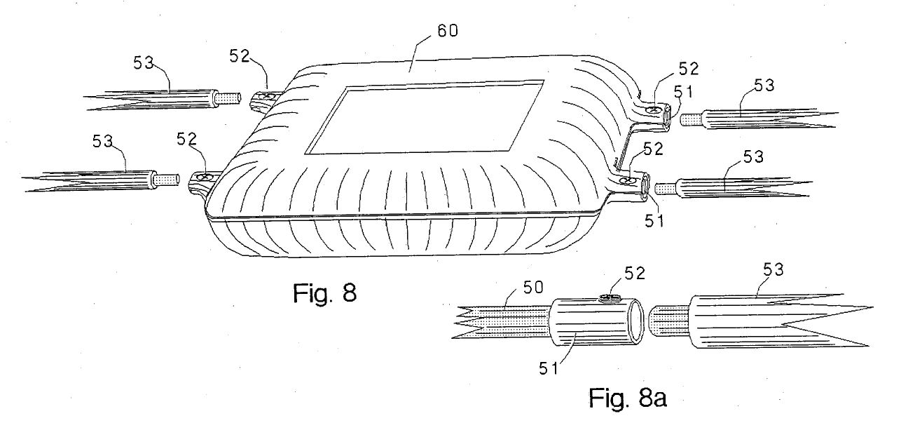

FIG. 8 shows the relay portion of the automatic booster cable system in its case without the cables 53 being directly attached. FIG. 8a shows a detail for a method whereby the cables 53 can be attached to the system. In FIG. 8a, a conductor end 50 extending within the relay is attached to hollow member or sleeve 51 for example either by soldering or staking. Sleeve 51 features a threaded hole and screw 52. The screw is a set-screw to hold the core conductor of the external cable 53 firmly inside member 51. Other user-accessible connection means can be employed. In this way, the assembly of the relay portion of the booster system can be sold separately and completed by assembly with external cables at a later time.

### CONCLUSION

The foregoing has constituted a description of specific embodiments showing how the invention may be applied and put into use. These embodiments are only exemplary. The invention in its broadest, and more specific aspects, is further described and defined in claims which now follow.

These claims, and the language used therein, are to be understood in terms of the variants of the invention which have been described. They are not to be restricted to such variants, but are to be read as covering the full scope of the invention as it is implicit within the invention and the disclosure that has been provided herein.

1. A multi-pole switching system comprising:
a) a series of parallel contactor bars supported in a non-conductive frame and interspaced with shiftable contactors, the shiftable contractors each having generally centrally located support openings;
b) wiring connection means for coupling the contactor bars to external wiring;
c) an alignment shaft whereon said shiftable contactors are slideably mounted through said support openings;
the shiftable contactors being positioned to effect contact with the contactor bars by advancement along the alignment shaft and thereby achieve switch closure.

2. A switching system as in claim 1 comprising drive means for displacing the shiftable contactors along the alignment shaft to effect switch closure.

3. A switching system as in claim 2 comprising first resilient, nonconductive, first spring means positioned along the alignment shaft to bias the shiftable contactors to move, upon deactivation of the drive means, into a neutral condition.

4. A switching system as in claim 3 comprising second resilient, nonconductive, second spring means positioned along the alignment shaft, adjacent the shiftable contactors to press the shiftable contactors resiliently against the contactor bars to obtain a good elecrical contact.

5. A switching system as in claim 3 wherein said spring means is provided by silicone rubber.

6. A switching system as in claim 1 wherein said contactor bars and shiftable contactors are assembled in combinations that will constitute switch closures for either of the two conducting configurations of a double-pole, double-throw switch or constitute a neutral position providing an ‘open’ condition.

7. A switching system as in claim 6 comprising solenoid means for displacing the shiftable contactors along the alignment shaft to effect switch closure.

8. A switching system as in claim 1 in combination with a plurality of conductors to be connected to said external wiring wherein a conductor-receiving opening is formed in an end of each contactor bar and the conductors are directly coupled to the fixed contactor bars by the compressed engagement of the ends of said contactor bars around such conductors when positioned within said openings.

9. A switching system as in claim 8 wherein at least one of said conductors is directly connected to more than one contactor bar.

10. A system as in claim 8 wherein the conductors are free of curvature as they engage with such contactor bars.

11. A system as in claim 10 wherein the conductors are free of curvature as they approach such contactor bars.

12. A switching system as in claim 11 wherein such conductors are fixed to eliminate their movement during operation of the switch.

13. A switching system as in claim 7 comprising electronic means to effect operation of the solenoid means to provide a relay.

14. A switching system as in claim 13 for providing current from a supply source through cables to a battery to be charged comprising:
a) first electrical circuit means for sensing the voltage of the battery to be charged, said first electrical circuit means having means for being connected to said battery to be charged through cables;
b) multiple solenoids actuatable by said first electrical circuit to advance the shiftable contactors along the alignment shaft respectively in both directions;
c) means associated with said first circuit means to permit activation of the solenoids only when the cables are in contact with a battery to be charged that has a voltage that is over a preselected threshold voltage level.

15. A switching system as in claim 12 in combination with a second electrical circuit means for sensing when not all of the cables are connected to either the supply source or the battery to be charged and thereupon for correspondingly deactivating said solenoids, said second electrical circuit means comprising:
a) a pulse generator which provides an output pulse with a short-term duty cycle for disabling activation of the solenoids by the first electrical circuit means for the duration of the pulse;
wherein said pulse generator is connected to said first electrical circuit means to place the switch in a neutral position for the duration of said pulse, whereafter the first electrical circuit means is operative to ensure that, if any of the cables are disconnected during the output pulse, then the switching system will stay in its neutral position upon the termination of said output pulse.

16. A system as in claim 15 comprising a third electrical circuit means connected to disable said pulse generator and suspend the generation of pulses when the current flowing through the switch is above a threshold current value.

17. A switching system as in claim 16 wherein said third electrical circuit means establishes that said current is over said threshold current value by sensing when the voltage of the supply source drops below a threshold voltage value.

18. A switching system as in claim 17 wherein said threshold voltage value is in the range of 10 to 11 volts.

19. A switching system as in claim 7 comprising coupling means for attaching cables to said by which the switching system may be used to connect to batteries in parallel.
